(19) United States
(12) Patent Application Publication
(10) Pub. No.: US 2022/0180624 A1
(43) Pub. Date: Jun. 9, 2022

(54) METHOD AND DEVICE FOR AUTOMATIC IDENTIFICATION OF LABELS OF AN IMAGE

(71) Applicant: BOE Technology Group Co., Ltd., Beijing (CN)

(72) Inventors: Yue LI, Beijing (CN); Tingting WANG, Beijing (CN)

(21) Appl. No.: 16/611,463

(22) PCT Filed: Mar. 11, 2019
(86) PCT No.: PCT/CN2019/077671

§ 371 Date: Nov. 6, 2019

(30) Foreign Application Priority Data
Oct. 16, 2018 (CN) 201811202664.0

(51) Int. Cl. G06V 10/77; G06V 10/44

(52) U.S. Cl. CPC G06V 10/7715; G06V 10/44

(57) ABSTRACT

Disclosed herein is a method comprising: determining a first value of a single-label of an image and a first value of a multi-label of the image, based on a feature map of the image; producing a weighted feature map from the feature map based on a characteristic of features of the feature map; determining a second value of the multi-label of the image by performing spatial regularization on the weighted feature map; determining a third value of the multi-label based on the first value of the multi-label and the second value of the multi-label.

### CROSS-REFERENCE TO RELATED APPLICATION

This application claims priority to Chinese Patent Application No. 201811202664.0, filed on Oct. 16, 2018, the contents of which are incorporated by reference in the entirety.

### TECHNICAL FIELD

The disclosure herein relates to identification of labels of an image, particularly relates a method and a device to automatically identify multi-label of an image.

### BACKGROUND

Classification for multi-label of an image is very challenging. It has wide application in areas such as scene identification, multi-target identification, human body attributes identification, etc.

### SUMMARY

Disclosed herein is a computer-implemented method for identifying labels of an image comprising: determining a first value of a single-label of the image and a first value of a multi-label of the image, based on a feature map of the image; producing a weighted feature map from the feature map based on a characteristic of features of the feature map; determining a second value of the multi-label of the image by performing spatial regularization on the weighted feature map; determining, with a processor, a third value of the multi-label based on the first value of the multi-label and the second value of the multi-label.

According to an embodiment, the characteristic is correlation of the features with the multi-label.

According to an embodiment, the correlation is spatial correlation or sematic correlation.

According to an embodiment, the third value of the multi-label is a weighted average of the first value of the multi-label and the second value of the multi-label.

According to an embodiment, the method further comprises determining a fourth value of the multi-label from the third value of the multi-label based on sematic correlation between the single-label and the multi-label.

According to an embodiment, the method further comprises applying a threshold to the fourth value of the multi-label.

According to an embodiment, the method further comprises determining a second value of the single-label from the first value of the single-label based on sematic correlation between the single-label and the multi-label.

According to an embodiment, the method further comprises extracting the feature map from the image.

According to an embodiment, the multi-label is a subject label or a content label.

According to an embodiment, the single-label is a class label.

According to an embodiment, producing the weighted feature map comprises using a global pooling layer, a first convolution layer, a nonlinear activation function, a second convolution layer and a linear activation function.

According to an embodiment, producing the weighted feature map comprises obtaining importance degree of each feature channel based on the feature map and enhancing those feature channels that have high importance degree.

According to an embodiment, the method further comprises extracting high-level semantic features of the image from the feature map.

According to an embodiment, the method further comprises applying a threshold to the first value of the single-label.

Disclosed herein is a computer program product comprising a non-transitory computer readable medium having instructions recorded thereon, the instructions when executed by a computer implementing an of the methods above.

Disclosed herein is a computer system comprising: a first microprocessor configured to determine a first value of a single-label of an image and a first value of a multi-label of the image, based on a feature map of the image; a second microprocessor configured to produce a weighted feature map from the feature map based on a characteristic of features of the feature map; a third microprocessor configured to determine a second value of the multi-label of the image by performing spatial regularization on the weighted feature map; a fourth microprocessor configured to determine a third value of the multi-label based on the first value of the multi-label and the second value of the multi-label. The microprocessors here may be physical microprocessors or logical microprocessors. For examples, the first, second, third, and fourth microprocessors may be logical microprocessors implemented by one or more physical microprocessors.

According to an embodiment, the characteristic is correlation of the features with the multi-label.

According to an embodiment, the correlation is spatial correlation or sematic correlation.

According to an embodiment, the third value of the multi-label is a weighted average of the first value of the multi-label and the second value of the multi-label.

According to an embodiment, the computer system further comprises a fifth microprocessor configured to determine a fourth value of the multi-label from the third value of the multi-label based on sematic correlation between the single-label and the multi-label.

According to an embodiment, the fifth microprocessor is further configured to apply a threshold to the fourth value of the multi-label.

According to an embodiment, the computer system further comprises a sixth microprocessor configured to determine a second value of the single-label from the first value of the single-label based on sematic correlation between the single-label and the multi-label.

According to an embodiment, the computer system further comprises a seventh microprocessor configured to extract the feature map from the image.

Further disclosed herein is a system comprising a main net, a feature enhancement network module, a spatial regularization net and a weighting module; wherein the main net is configured to obtain a feature map from an image, determine a first value of a single-label of the image and a first value of a multi-label of the image based on the feature map; wherein the feature enhancement network module is configured to produce a weighted feature map from the feature map; wherein the spatial regularization net is configured to determine a second value of the multi-label of the image by performing spatial regularization on the weighted feature map; wherein the weighting module is configured to determine a third value of the multi-label based on the first value of the multi-label and the second value of the multi-label.

According to an embodiment, the feature enhancement network module is configured to produce the weighted feature map based on importance degrees of feature channels in the feature map.

According to an embodiment, the weighting module is configured to determine a third value of the multi-label based on a weighted average of the first value of the multi-label and the second value of the multi-label.

According to an embodiment, the feature enhancement network module comprises a first convolution module that comprises a global pooling layer, a first convolution layer, a nonlinear activation function, a second convolution layer and a linear activation function.

According to an embodiment, the system further comprises a feature extraction module configured to extract high-level semantic features from the feature map.

Disclosed herein is a method for automatically identifying a multi-label of an image, comprising: using a main net to extract a feature map from the image and to obtain a prediction result ŷ_{class} of a class label, a prediction result ŷₜₕₑₘₑ of a theme label and a first prediction result ŷ_{content-1} of a content label; using a feature enhancement module to obtain importance degree of each feature channel based on the feature map, to enhance features having high importance degree in the feature map according to the importance degree of each feature channel, and to output an enhanced feature map; inputting the enhanced feature map into a spatial regularization net and producing a second prediction result ŷ_{content-2} of the content label by the spatial regularization net; obtaining a weighted average ŷ_{content} of the first prediction result ŷ_{content-1} and second prediction result ŷ_{content-2}; generating a label set for the image from a label prediction result vector y₁=(ŷ_{class},ŷₜₕₑₘₑ,ŷ_{content}) comprising the prediction result ŷ_{class}, the prediction result ŷₜₕₑₘₑ, and the weighted average ŷ_{content}.

According to an embodiment, the feature enhancement module comprising a first convolution module with a global pooling layer, a first convolution layer, a nonlinear activation function, a second convolution layer and a linear activation function, sequentially connected; wherein outputting the enhanced feature map comprises using weighted values for the feature channels.

According to an embodiment, before the feature enhancement module, using a second convolution module to extract advanced semantic features from the image overall.

According to an embodiment, the first convolution module and the second convolution module constitute an integrated convolution structure, and the number of concatenated convolution structures connected is set by a hyperparameter M, M being an integer greater than or equal to 2 and determined based on a number of different labels and a size of a training data set.

According to an embodiment, generating the set of labels further comprises processing the prediction result vector by a K-dimensional full connection module to output a semantic association enhanced label prediction result vector y₂=(ŷ_{class}′,ŷₜₕₑₘₑ′,ŷ_{content}′), wherein K is the number of the labels (including a class tag, a theme label, and the content label), ŷ_{class}′ is a class label prediction result enhanced by semantic association, ŷₜₕₑₘₑ′ is a theme label prediction result enhanced by semantic association, and ŷ_{content}′ is a content label prediction result enhanced by semantic association.

According to an embodiment, ŷₜₕₑₘₑ′ and y̅_{content}′ are respectively compared with respective confidence thresholds to determine whether each of the labels exists.

According to an embodiment, further comprising using a threshold setting module to obtain the confidence thresholds by regression.

According to an embodiment, the threshold setting module comprises a two-layer convolution network con n×1 and con 1×n, the two-layer convolution network con n×1 and con 1×n are respectively connected to a network structure of the batch norm and relu functions, wherein n is adjusted according to the number of labels and a training effect.

According to an embodiment, the following training steps are further included prior to identifying labels of the image: training the first network parameter of the main net with all label data, and fixing the first network parameter; training the second network parameter of the feature enhancement module and the spatial regularization module by using training data with a content label, and fixing the second network parameter is fixed.

According to an embodiment, the following training steps are further included before processing the label prediction result vector by the K-dimensional full connection module: the third network parameter of the full-connected module is trained by using all the label data, and the third network parameter is fixed, while the first network parameter and the second network parameter are trained and fixed.

According to an embodiment, the training using the threshold setting module to obtain the confidence threshold is performed by training and fixing the first network parameter, the second network parameter, and the third network parameter.

Disclosed herein is an apparatus for automatically identifying multiple labels of an image.

Disclosed herein is a computer device for automatically identifying multiple labels of an image, comprising: one or more processors and a memory coupled to the one or more processors, the memory storing instructions that, when executed by the one or more processors, cause the computer device to perform any of the methods above.

### BRIEF DESCRIPTION OF FIGURES

FIG. 1 schematically shows a flowchart of a method to automatically identify multi-label of an image, according to an embodiment.

FIG. 2 schematically shows an exemplary block diagram of a device to automatically identify multi-label of an image, according to an embodiment.

FIG. 3 schematically shows a convolution structure, according to an embodiment.

FIG. 4 schematically shows another convolution structure, according to another embodiment.

FIG. 5 schematically shows a convolution structure in a threshold value setting module, according to an embodiment.

FIG. 6 schematically shows another exemplary block diagram of a device to automatically identify multi-label of an image, according to an embodiment.

### DETAILED DESCRIPTION

As to an image (for example, a painting), its labels are generally divided into: class label (for example, Chinese painting, oil painting, sketch, water-powder color, etc.), subject label (for example, scenery, person, animal, etc.), and content label (for example, sky, house, mountain, water, horse, etc.), etc. Here, class label and subject label are identified based on whole features of an image, and content label is identified based on local features of an image.

Image label identification methods currently available are mainly divided into single-label identification and multi-label identification. There is a certain difference between the two types of identification methods. The single-label identification method is based on a basic classification network; mostly, the multi-label identification is based on attention mechanism, identifying labels by local key features and position information, and is suitable to identify labels by various local comparison of two similar subjects. However, existing methods are all based on ordinary images (for example, photo, picture or painting) to obtain corresponding content labels or scene labels, without considering features of an image (for example, artistic painting), so that effect of identification is poor. Also, a separate network is needed to respectively obtain single-label and multi-label, so that calculation task of a model is large. Labels related to an image can be categorized as: class label, subject label, content label, etc. Using a painting as an example, a class label can be, for example, Chinese painting, oil painting, sketch, watercolor painting, etc.; a subject label can be, for example, landscape, people, animal, etc.; and a content label can be sky, house, mountain, water, horse, etc. A class label is single-label, i.e., each image (such as an oil painting, a sketch, etc.) only corresponds to one class label. Subject labels and content labels are multi-label, i.e., an image (for example, an image comprising a landscape and people, comprising the sky and horses, etc.) can correspond to multiple labels. Features of an images can be classified as overall features and local features. The class label and subject labels are classified according to overall features of an image, and content labels are classified according to local features of an image (i.e., identification is done using local features of an image).

This disclosure provides methods and systems that can identify multi-labels and single-labels of an image without using two separate networks, especially when the image is an artwork, thereby reducing the amount of computation. The methods and systems here also may take sematic correlation among the labels into consideration, thereby increasing the accuracy of the identification of the labels.

The spatial regularization network model is used as a basic model herein. The spatial regularization network model comprises two main components: a main net and a spatial regularization net. The main net is mainly used to do classification based on overall features of an image. The spatial regularization net is mainly used to do classification based on local features of an image.

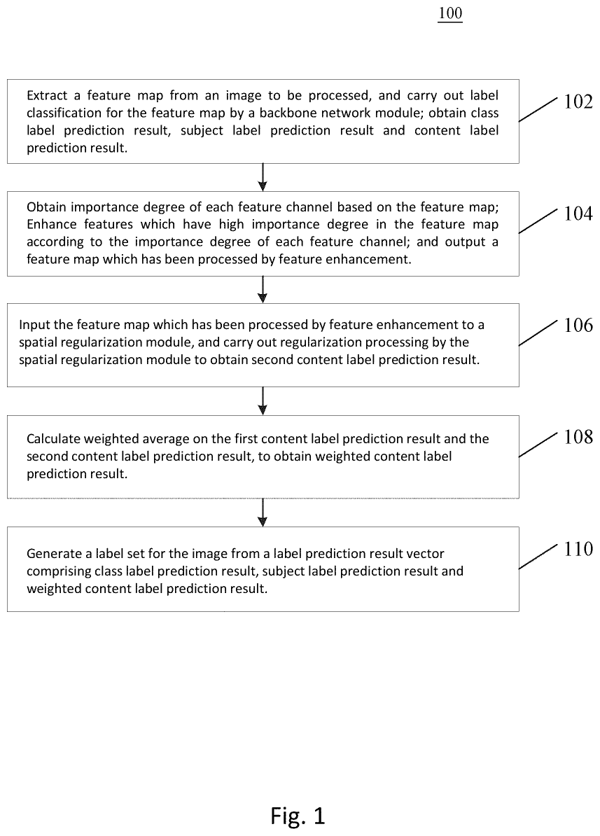

FIG. 1 schematically shows a flowchart of a method 100 to automatically identify multi-label of an image, according to an embodiment. The method can be implemented with any suitable hardware, software, firmware, or combination thereof.

In step 102, a feature map is extracted from an image to be processed by a main net. In some embodiments, the feature map may be three-dimension W×H×C. Here W represents width, H represents height, and C represents number of feature channels. The main net also carries out label classification for the feature map to obtain image class label prediction result ŷ_{class} (first value of a single-label of the image), image subject label prediction result ŷₜₕₑₘₑ (first value of a multi-label of the image), and image first content label prediction result ŷ_{content-1} (first value of a multi-label of the image). The first content label prediction result is also content label prediction result of feature extraction by the main net. Optionally, after an image is converted to a predetermined size (for example, 224×224), the image is input to the main net to be processed.

The main net can have various convolution structures, such as deep residual network ResNet 101, LeNet, AlexNet, GoogLeNet, etc. Exemplarily, under the condition that the main net is ResNet 101, the main net comprises, for example, a convolution layer ResNet Conv 1-5, an average pooling layer and a full-connection layer. The specific structure of the ResNet 101 can be shown in table 1. More information about ResNet 101 may be found in a publication titled “Learning Spatial Regularization with Image-Level Supervisions for Multi-Label Image Classification” by F. Zhu, et al., The IEEE Conference on Computer Vision and Pattern Recognition (CVPR) 2017, pp. 5513-5522, the contents of which are incorporated by reference in its entirety.

TABLE 1
Exemplary convolution structure of ResNet 101.

| Layer | Output | | | | | |
|---|---|---|---|---|---|---|
| Name | Size | 18-Layer | [symbol] -Layer | 50-Layer | 101-Layer | 152-Layer |
| Conv 1 | 112 × 112 | 7 × 7, 64 step 2 | | | | |
| Conv | 56 × 56 | 3 × 3 maximum pooling, step 2 | | | | |
| 2_x | | $[ \begin{matrix}3 \times 3 & 64 \\ 3 \times 3 & 64\end{matrix} ] \times 2$ | $[ \begin{matrix}3 \times 3 & 64 \\ 3 \times 3 & 64\end{matrix} ] \times 3$ | $[ \begin{matrix}1 \times 1 & 64 \\ 3 \times 3 & 64 \\ 1 \times 1 & 256\end{matrix} ] \times 3$ | $[ \begin{matrix}1 \times 1 & 64 \\ 3 \times 3 & 64 \\ 1 \times 1 & 256\end{matrix} ] \times 3$ | $[ \begin{matrix}1 \times 1 & 64 \\ 3 \times 3 & 64 \\ 1 \times 1 & 256\end{matrix} ] \times 3$ |
| Conv [symbol] | 28 × 28 | $[ \begin{matrix}3 \times 3 & 128 \\ 3 \times 3 & 128\end{matrix} ] \times 2$ | $[ \begin{matrix}3 \times 3 & 128 \\ 3 \times 3 & 128\end{matrix} ] \times 4$ | $[ \begin{matrix}1 \times 1 & 128 \\ 3 \times 3 & 128 \\ 1 \times 1 & 512\end{matrix} ] \times 4$ | $[ \begin{matrix}1 \times 1 & 128 \\ 3 \times 3 & 128 \\ 1 \times 1 & 512\end{matrix} ] \times 4$ | $[ \begin{matrix}1 \times 1 & 128 \\ 3 \times 3 & 128 \\ 1 \times 1 & 512\end{matrix} ] \times 8$ |
| Conv 4_x | 14 × 14 | $[ \begin{matrix}3 \times 3 & 256 \\ 3 \times 3 & 256\end{matrix} ] \times 2$ | $[ \begin{matrix}3 \times 3 & 256 \\ 3 \times 3 & 256\end{matrix} ] \times 6$ | $[ \begin{matrix}1 \times 1 & 256 \\ 3 \times 3 & 256 \\ 1 \times 1 & 1024\end{matrix} ] \times 6$ | $[ \begin{matrix}1 \times 1 & 256 \\ 3 \times 3 & 256 \\ 1 \times 1 & 1024\end{matrix} ] \times 23$ | $[ \begin{matrix}1 \times 1 & 256 \\ 3 \times 3 & 256 \\ 1 \times 1 & 1024\end{matrix} ] \times 36$ |
| Conv 5_x | 7 × 7 | $[ \begin{matrix}3 \times 3 & 512 \\ 3 \times 3 & 512\end{matrix} ] \times 2$ | $[ \begin{matrix}3 \times 3 & 512 \\ 3 \times 3 & 512\end{matrix} ] \times 3$ | $[ \begin{matrix}1 \times 1 & 512 \\ 3 \times 3 & 512 \\ 1 \times 1 & 2048\end{matrix} ] \times 3$ | $[ \begin{matrix}1 \times 1 & 512 \\ 3 \times 3 & 512 \\ 1 \times 1 & 2048\end{matrix} ] \times 3$ | $[ \begin{matrix}1 \times 1 & 512 \\ 3 \times 3 & 512 \\ 1 \times 1 & 2048\end{matrix} ] \times 3$ |

| | |
|---|---|
| 1 × 1 | Average pooling, 1000- [symbol] , softmax |

[symbol]

indicates data missing or illegible when filed

According to an embodiment, the ResNet CONV 1-4 in the main net is used to extract a feature map from the image to be processed. According to an embodiment, in the main net, the ResNet CONV 5, the average pooling layer and the full-connection layer are used to carry out label classification for the feature map.

In step 104, a feature enhancement module is used to obtain importance degree of each feature channel based on the feature map, enhance the features which have high importance degree in the feature map according to the importance degree of each feature channel, and output a feature map which has been processed by feature enhancement. The characteristic of each feature channel of the feature map can highlight some information (for example, values at certain positions are large). The importance degree of a feature channel may be determined based on degree of correlation with the feature of a label to be identified. In some embodiments, to identify a label, determination of the importance degree of the feature channel can be carried out by deciding whether the feature channel has characteristic distribution in agreement with the characteristic of the label. When a certain feature channel has characteristic distribution in agreement with the characteristic of the label, it can be determined that the feature channel has high importance degree, or it can be determined that the feature channel is useful. Otherwise, the feature channel is not important or is not very useful. The position where the label is present can be highlighted by enhancing the feature channel with high importance degree. For example, under the condition that the label to be identified comprises a solar label, because the sun mostly appears in an upper position in an image, if numerical value of an element at an upper position of a feature map of a certain feature channel is large, the importance degree of the feature channel is regarded to be high.

In some embodiments, a feature enhancement module enhances the features which have high importance degree in the feature map, by generating weighted values corresponding to each feature channel and weighting the feature channels with the weighted values. In these embodiments, a feature, which has high importance degree, is given large weighted value.

In step 106, a feature map, which has been processed by feature enhancement, is input into a spatial regularization net. A second content label prediction result ŷ_{content-2} is obtained by regularization processing in the spatial regularization net. The second content label prediction result ŷ_{content-2} (second value of a multi-label of the image) is content label prediction result which has been processed by regularization. According to an embodiment, the spatial regularization net is configured to distinguish local image features and carry out spatial correlation with label semantics. Optionally, the spatial regularization net can be configured to extract attention feature and to do regularization processing for the feature map.

In step 108, the weighted average of the first content label prediction result ŷ_{content-1} and the second content label prediction result ŷ_{content-2} is calculated to obtain weighted content label prediction result ŷ_{content} (third value of a multi-label of the image). The weighted average may be, for example, y_{content}=½y_{content-1}+½y_{content-2}, or, the weighted average may also be calculated using other suitable weighting coefficients.

In step 110, a label set for the image is generated from a label prediction result vector y₁=(ŷ_{class},ŷₜₕₑₘₑ,ŷ_{content}) comprising class label prediction result ŷ_{class}, subject label prediction result ŷₜₕₑₘₑ and weighted content label prediction result ŷ_{content}.

The scheme disclosed herein can give more consideration on relative relation (for example, importance degree) among feature channels. The importance degree of each feature channel is automatically obtained in a way of learning, so that useful features are enhanced and the features which is not very useful is weakened. As a preprocessing way to distinguish local features, the feature enhancement method may provide a more distinguishing feature map for later generation of an attention map of each label, according to an embodiment.

In some embodiments, the scheme disclosed herein considers that there is a strong semantic correlation among various image labels (for example, class label and subject label, content label and class label, etc.). For example, bamboo content label often appears in works such as Chinese painting, and religious subject label often appears in an oil painting. In order to enhance the correlation among the labels, after label prediction result vector is obtained, label sematic correlation is enhanced again. For example, the label prediction result vector Y: can be processed by K-dimensional full-connection module, in order to output a label prediction result vector y₂=(ŷ_{class}′,ŷₜₕₑₘₑ′,ŷ_{content}′), which has been processed by sematic correlation enhancement. Here, K is the number of all labels to be identified, comprising class label, subject label and content label; ŷ_{class}′ (second value of the single-label of the image) is class label prediction result, which has been processed by sematic correlation enhancement; ŷₜₕₑₘₑ′ (fourth value of a multi-label of the image) is subject label prediction result, which has been processed by sematic correlation enhancement; and ŷ_{content}′ (fourth value of a multi-label of the image) is content label prediction result, which has been processed by sematic correlation enhancement. Alternatively, weighting relationship (i.e., weighted values) among various labels can be obtained through learning, so that identification result y2, which is after integral label semantic correlation, is obtained.

In some embodiments, because class label is single-label, softmax function calculation can be directly carried out on output of class label prediction result vector, and a label with the highest confidence degree is set to be predicted class label. Input of softmax function is a vector yclass, and output is a normalized vector, namely, each element in the vector is confidence degree corresponding to each class. After normalization, the sum of the elements is 1. For example, after using softmax function to calculate image class label prediction result, if the result is: 0.1 for Chinese painting; 0.2 for oil painting; 0.4 for sketch and 0.3 for water-powder color, then it is determined that the result of the predicted class label is sketch label, which has the highest confidence degree.

In some embodiments, both subject label and content label belong to multi-label classification, namely, an image can correspond to a plurality of labels (for example, the image may comprise both a landscape and people, may comprises both the sky and horses, etc.). Their confidence degrees can be screened with a threshold value θ, that is, if the confidence degree of a label prediction is larger than the threshold value θ, the label prediction is set to be true (i.e., the label is present); otherwise, the label prediction is set to be false (i.e., the label does not exist). Exemplarily, the screening with the threshold θ can be carried out with the following formula (1):

$$\hat{Y} = \begin{matrix}1 & if {f}_{k} \geq 0 \\ 0 & otherwise\end{matrix} , ∀ k ∈ [ 1 , K ] \qquad ( 1 )$$

Where K is the number of subject and content labels, ƒᵢ is confidence degree for each label prediction, θ is confidence threshold value, Ŷ is final prediction result for subject label and content label.

The identification difficulty for each label may be different. The size of training data and its distribution may be different. As a result, if a unified threshold value g is set for confidence degree thresholds of all kinds of label, the recognition accuracy of certain labels can be low. In some embodiments, a unified threshold is not used. Instead, for each kind of subject material and content label, corresponding confidence degree threshold value θ can be obtained through training. For example, a regression learning mode can be used to obtain confidence degree threshold value θₖ for each kind of subject label and content label through training.

According to an embodiment, before using the method described above to automatically identify image multi-label, a process to train a model needs to be carried out.

In first stage of training, before automatically identifying labels in an image, first network parameters of the main net are trained through all label training data. For example, ResNet 101 is used as a main net, only CONV 1-4 and CONV 5 can be trained. The main net is trained to output class label prediction result ŷ_{class}, subject label prediction result ŷₜₕₑₘₑ and first content label prediction result ŷ_{content-1}. The first stage of training can be carried out by using loss function. The loss function of the first training stage is set as: loss₁=loss_{class}+lossₜₕₑₘₑ+loss_{content-1}; Here, the class label loss function loss_{class} can be calculated in the way of softmax cross entropy loss function, the subject label loss function lossₜₕₑₘₑ and the content label loss function loss_{content-1} can be calculated in the way of a sigmoid cross entropy loss function.

In second training stage, under the condition that parameters of the first network parameter are fixed, second network parameters of the feature enhancement module and the spatial regularization net can be trained with training data which has content labels. The feature enhancement module and the spatial regularization net are trained to output second content label prediction result ŷ_{content-2}. The loss function of the second training stage is set to be loss₃=loss_{content-2}.

Weighted average of the first content label prediction result ŷ_{content-1} and the second content label prediction result ŷ_{content-2} is calculated to obtain weighted content label prediction result ŷ_{content}. The weighted average may be, for example, calculated using ŷ_{content}=½y_{content-1}+½y_{content-2}, or calculated using other weighting coefficients.

The training data may comprise images, and real labels corresponding to each image. Here the labels can be one or more of class label, subject label and content label. For example, real labels of an image, which can be obtained by manually labeling, may be oil painting (class label), landscape (subject label), drawing (subject label), person (content label), mountain (content label) and water (content label). In training process, all images and labels can be used in some training stages, images with a certain or some specific classifications (such as one or more of class, subject, and content) can be used in some training stages. For example, in second training stage, the network is trained only by images which have content labels.

Optionally, under the condition that label prediction result vector y1 is processed by the K-dimensional full-connection module, the training process further comprises a third training stage. In the third training stage, before the label prediction result vector y1 is processed by the K-dimensional full-connection module, under the condition that the first network parameters and the second network parameters have already been trained and fixed, third network parameters of the K-dimensional full-connection module can be trained using all training data, namely, weighted parameters among labels are trained. The K-dimensional full-connection module is trained to output a label prediction result vector y₂=(ŷ_{class}′,ŷₜₕₑₘₑ′,ŷ_{content}′), which has been processed by semantic label relation enhancement. Here K is the number of all labels comprising class label, subject label and content label. ŷ_{class}′ is class label prediction result which has been processed by sematic correlation enhancement. ŷₜₕₑₘₑ′ is subject label prediction result which has been processed by sematic correlation enhancement. ŷ_{content}′ is content label prediction result which has been processed by sematic correlation enhancement. The loss function of the third training stage is set to be loss₃=loss_{class}+lossₜₕₑₘₑ+loss_{content}.

Optionally, the training process may further comprise a fourth training stage. The fourth training stage is used to respectively obtain confidence degree threshold value θₖ for each subject label and content label. In the fourth training stage, class label ŷ_{class} which has been obtained in the third training stage and which has highest value of softmax value of confidence degree, is set as class label of the image. All network parameters of first to third training stages (i.e., obtained by the first, second and third networks) are fixed. Only parameters of threshold value regression model, which is used in threshold training, are trained. Loss function of fourth training stage is set to be

lossᵢ=−Σᵢ₌₁^{I}Σⱼ₌₁^{J}Y_{i,j} log(sigmoid(ƒⱼ(xᵢ)−θⱼ))+(1−Y_{i,j} log(1−sigmoid(ƒⱼ(xᵢ)−θⱼ)).

Here i refers that i-th image of the training, j refers to j-th label, Y_{i,j} refers to groundtruth of the j-th label (0 or 1), ƒⱼ(xᵢ) and θⱼ respectively refer to confidence degree and threshold value of the j-th label. Based on the loss function, the threshold θⱼ which corresponds to label j is obtained. So that subject and content label confidence degree prediction result, which is after screening with threshold value, is obtained and used as final prediction result of subject and content label. The combination of the three types of labels is final label prediction result.

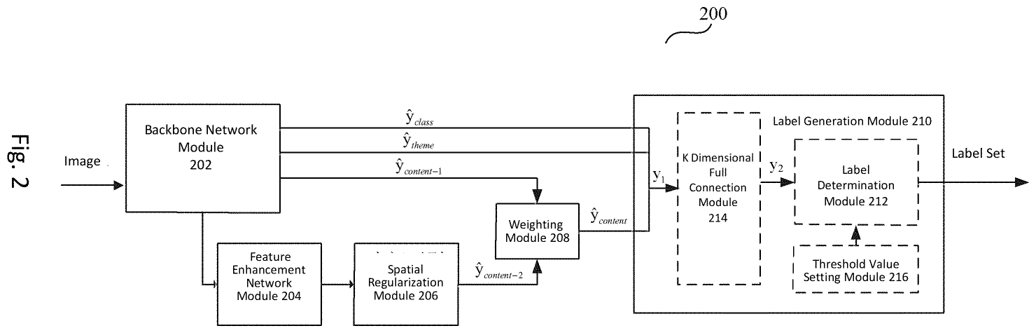

FIG. 2 shows a block diagram of a device 200, which is used to automatically identify multi-label of an image. The device 200 mainly comprises a main net 202, a feature enhancement network module 204, a spatial regularization net 206, a weighting module 208 and a label generation module 210.

The main net 202 is configured to extract a feature map from the image to be processed. The feature map is 3-dimension W×H×C. Here W represents width, H represents height, and C represents the number of feature channels. The main net 202 is further configured to perform label classification on the feature map, to obtain class label prediction result ŷ_{class}, subject label prediction result ŷₜₕₑₘₑ and first content label prediction result ŷ_{content-1} for the image. Exemplarily, under the condition that the main net is ResNet 101, ResNet Conv 1-4 in the ResNet 101 is used to extract a feature map from the image to be processed. In an embodiment, ResNet Conv 5, an average pooling and a full-connection layer in the ResNet 101 are used to carry out label classification on the feature map, and output class label prediction result ŷ_{class}, subject label prediction result ŷₜₕₑₘₑ and first content label prediction result ŷ_{content-1} for the image.

The feature enhancement module 204 is configured to obtain importance degree of each feature channel based on the feature map; enhance the features which have high importance degree in the feature map, according to importance degree of each feature channel; and output a feature map which has been processed by feature enhancement. Specifically, the feature enhancement module is implemented by a convolution structure.

The spatial regularization net 206 is configured to perform regularization processing on the feature map which has been processed by feature enhancement, to obtain second content label prediction result ŷ_{content-2} of the image. In an embodiment, the spatial regularization net comprises an attention network, a confidence degree network, and a spatial regularization network. The attention network is configured to generate an attention map. The number of the channels of the attention map is the same as the number of the content labels. The confidence degree network is used to do further weighting for the attention map. The number of the channels of the attention map is in consistent with the number of the content labels, namely, the attention map of each channel represents characteristic distribution of a content label classification. When weighting is carried out through the confidence degree network, the attention maps corresponding to content labels which are present in the current image can be given large weight, and the attention maps corresponding to content labels which are not present in the current image can be given small weight. In this way, whether a content label is present can be determined. The spatial regularization network is used to carry out semantic and spatial correlation for result output by the attention map. In this embodiment, the spatial regularization net 206 is configured to perform attention feature extraction from the feature map which has been processed by feature enhancement, and perform regularization processing, in order to obtain second content label prediction result of the image.

The weighting module 208 is configured to calculate weighted average on the first content label prediction result ŷ_{content-1} and the second content label prediction result ŷ_{content-2}, to obtain weighted content label prediction result ŷ_{content}. The weighted averaging, for example, may be calculated with content=½ŷ_{content-1}+½ŷ_{content-2}, or may be calculated with other suitable weighting coefficients.

The label generation module 210 is configured to generate a label set of the image from label prediction result vector y₁=(ŷ_{class},ŷₜₕₑₘₑ,ŷ_{content}) comprising class label prediction result ŷ_{class}, subject label prediction result ŷₜₕₑₘₑ and weighted content label prediction result ŷ_{content}. The label set comprises one or more of class label, subject label and content label. The class label can be single label. The subject label and content label can be multi-label. In some embodiments, the label generation module 210 can generate more than one subject label and/or content label for an image.

In some embodiments, the label generation module 210 comprises a label determination module 212, which is configured to determine label set of the image from the label prediction result vector y₁=(ŷ_{class},ŷₜₕₑₘₑ,ŷ_{content}) based on the confidence degree of the label prediction.

In some embodiments, in order to enhance sematic correlation of each main type of label, the label generation module 210 further comprises a K-dimensional full-connection module 214. The full-connection module 214 is configured to process label prediction result vector y₁ after it has been obtained by the full-connection module 214, to output a label prediction result vector y₂=(ŷ_{class}′,ŷₜₕₑₘₑ′,ŷ_{content}′), which has been processed by sematic correlation enhancement. Here K is the number of all labels comprising class label, subject label and content label. ŷ_{class}′ is class label prediction result which has been processed by sematic correlation enhancement. ŷₜₕₑₘₑ′ is subject label prediction result which has been processed by sematic correlation enhancement ŷ_{content}′ is content label prediction result which has been processed by sematic correlation enhancement. In the way of K elements full-connection-layer (K-d fc, K is the number of all labels to be identified), the K-dimensional full-connection module 214 can obtain the weighting relation among labels (i.e., weighted values) through learning, so that identification result y2, which has been processed by integral label semantic correlation, is obtained. In some embodiments, the label determination module 212 is configured to determine label set of the image according to label prediction result vector y₂=(ŷ_{class}′,ŷₜₕₑₘₑ′,ŷ_{content}′) which has been processed by sematic correlation enhancement, based on confidence degree of label prediction.

Subject label and content label belong to multi-label classification, so that their confidence degrees need to be determined by threshold values. In some embodiments, the label generation module 210 further comprises a threshold value setting module 216. The threshold value setting module 216 is configured to obtain and set confidence threshold value corresponding to each label (comprising subject label and content label) through training, using regression learning way. For example, if there are 10 subject labels and 10 content labels, there are 20 corresponding confidence degrees. In some embodiments, the label determination module 212 uses threshold values, which are set by the threshold value setting module 216, to determine whether each label exists or not.

The main net 202, the feature enhancement module 204 and the spatial regularization net 206 are further configured to perform training before labels in an image are automatically identified. First network parameters of the main net can be trained by all label data. In the example of using Resnet 101 as a main net, the first network parameters can comprise parameters for Resnet 101, Conv 1-Conv 4 and Conv 5. Under the condition that the parameters of the first network are fixed, parameters of the second network for the feature enhancement module and the spatial regularization net can be trained by using training data which has content labels.

In some embodiments, the K-dimensional full-connection module 212 is further configured to carry out training before processing label prediction result vector y₁. Here, K is the number of all labels comprising class label, subject labels and content labels. Under the condition that first network parameters and second network parameters are trained and fixed, third network parameters of the K-dimensional full-connection module, such as weighted parameters among labels, can be trained using all training data.

In some embodiments, under the condition that the first network parameters, the second network parameter and the third network parameter are trained and fixed, training the threshold value setting module 216 is carried out.

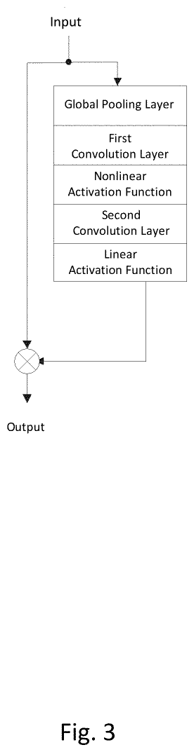

FIG. 3 schematically shows a convolution module which constructs a feature enhancement module, according to an embodiment. As shown in FIG. 3, the convolution module comprises a global pooling layer, a first convolution layer, a nonlinear activation function, a second convolution layer and an activation function, which are connected sequentially. By inputting a feature map and passing it through the convolution structure, weighted values for a plurality of feature channels can be generated and output. For example, the first convolution layer may be a 1*1*64 convolution layer, the nonlinear activation function can be relu function, the second convolution layer can be a 1*1*1024 convolution layer, and the activation function can be sigmoid function. The convolution module constructed in this way can generate weighted values for 1024 feature channels. It can be understood that the size of convolution kernel of the first and second convolution layers and the number of channels can be appropriately selected according to training and based on given implementation.

By superimposing generated weights on feature channels of the feature map, the features which have high importance degree in the feature map (namely, the features which have high correlation degree with labels to be identified) can be enhanced. Here, global pooling layer can use global maximum pooling or global average pooling. According to an embodiment, global maximum pooling or global average pooling can be selected according to actual enhancement effect. As known, relu function is an activation function. It is a piecewise linear function. It can change all negative values to be zero, and keep positive values unchanged. The sigmoid function is also an activation function. It can map a real number to the interval of (0, 1).

According to an embodiment, the number of convolution modules used in the feature enhancement module (i.e., convolution depth) can be set as a super parameter M. M is an integer larger than or equal to 2. When the feature enhancement module has a plurality of convolution modules, the convolution modules are sequentially connected in series. Alternatively, M may be determined based on number of different content labels and size of training data set. For example, when the number of labels is large and the size of the data set needed to be trained is large, M can be increased to make the network to be deeper. Optionally, if the size of the training data is small, for example, the number of the training images is tens of thousands, M can be selected to be two. If data volume of the training images is million-level, then M can be adjusted to be five. Additionally, M can also be adjusted according to training effect.

In some embodiments, before a feature map is input to the feature enhancement module, a feature extraction module can extract high-level semantic features corresponding to overall image in the feature map. The high-level semantic features pay more attention to semantic information, and pay less attention to detailed information. Low-level features contain more detailed information.

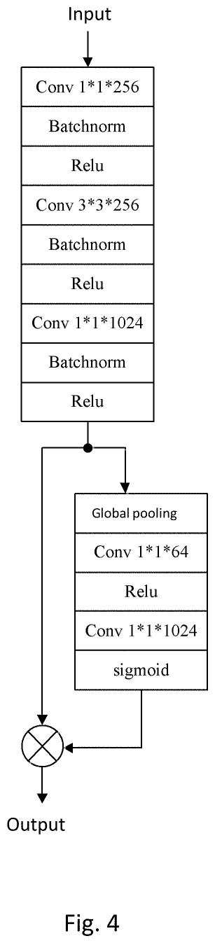

FIG. 4 schematically shows a convolution structure which constructs a feature extraction module and a feature enhancement module, according to an embodiment. The feature extraction module is composed of a first convolution module, and the feature enhancement module is composed of a second convolution module. For example, as shown in FIG. 4, the first convolution module may include three convolution layers, for example, a 1*1*256 convolution layer, a 3*3*256 convolution layer and a 1*1*1024 convolution layer. The second convolution module may comprise a global pooling layer, a 1*1*64 convolution layer, relu nonlinear activation function, 1*1*1024 convolution layer and sigmoid activation function.

When a feature map is input into the first convolution module, high-level semantic features of an overall image in the feature map can be extracted. The feature map, which has been processed by feature extraction, is then input to a second convolution module. The second convolution module can generate weighted values for 1024 feature channels. The generated weight is superimposed on output of original feature extraction module (i.e., the first convolution structure), in order to enhance features that have high importance degrees in the feature map.

Optionally, the first convolution module and the second convolution module can constitute an integrated convolution structure. A plurality of integrated convolution structures can be connected in series to achieve function of feature extraction and enhancement. The number of the integrated convolution structures connected in series can be set to be the super parameter M. M is an integer larger than or equal to 2.

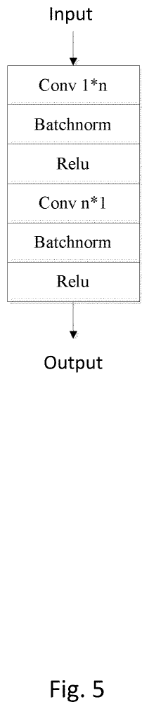

FIG. 5 shows a network structure of a threshold value setting module, according to an embodiment. As shown in FIG. 5, the network structure of the threshold value setting module comprises two convolution layers Con 1*n and Con n*1. Batchnorm and relu function are respectively connected behind each convolution layer. Here n can be adjusted according to the number of labels and training effect. Batchnorm is a common algorithm for accelerating neural network training, accelerating convergence speed and stability. In the network structure shown in FIG. 5, at each step of training, training data is input in batch. For example, 24 images are input at a time. In this case, after batchnorm is connected to the convolution layer, intermediate result can be obtained by convolution calculation, mean variance of the batch intermediate result can be calculated, and the batch intermediate result can be normalized, so that the problem of inconsistent input data distribution can be solved. In this way, absolute difference between images can be reduced, and relative difference can be highlighted, so that training speed is accelerated. In some embodiments, n can be increased or decreased according to training effect in an actual training process. In some embodiments, the larger the number of labels is, the larger the n is.

The threshold value setting module uses a threshold value regression model, which loss function is set to be:

lossᵢ=−Σᵢ₌₁^{I}Σⱼ₌₁^{J}Y_{i,j} log(sigmoid(ƒⱼ(xᵢ)−θⱼ))+(1−Y_{i,j})log(1−sigmoid(ƒⱼ

Here i is i-th training image, j is j-th label, Y_{i,j} is groundtruth (0 or 1) of the j-th label, ƒⱼ(xᵢ) and θⱼ are respectively confidence degree and threshold value for the j-th label. The confidence degree threshold θₖ corresponding to each label can be obtained and set by training the threshold value regression model. As known, in machine learning, groundtruth can represent accuracy of training set classification of supervised machine learning technology, and be used for proving or overthrowing a certain hypothesis in a statistical model. Exemplarily, when training, some images can be screened manually to serve as training data for model training. After then, labeling is also carried out manually (that is, which labels are contained in each image). The real label data corresponding to these images is groundtruth.

After confidence degree threshold value θₖ corresponding to each label is obtained, prediction structure of each label can be determined according to the following formula:

$${\hat{Y}}_{k} = \begin{matrix}1 , & if {f}_{k} \geq {θ}_{k} \\ 0 , & else\end{matrix} , \text{∀} k ∈ [ 1 , K ] \qquad ( 2 )$$

Here, K is the number of subject labels content labels, ƒₖ is confidence degree for each label prediction, θₖ is confidence degree threshold value of each label, and Ŷₖ is true or false result for finally predicted label.

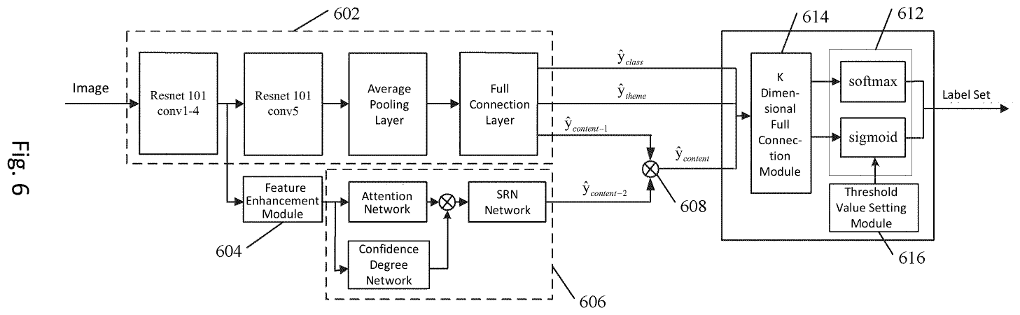

FIG. 6 shows another exemplary block diagram of a device to automatically identify multi-label of an image, according to an embodiment. As shown in FIG. 6, after the image is input into a main net 602, a plurality of convolution layers (namely, Resnet 101 Conv 1-4) are configured to extract a feature map from the image. The feature map can be sequentially processed by another convolution layer (namely Resnet 101 Conv 5), an average pooling layer and a full-connection layer in the main net 602. After then, for the image, class label prediction result ŷ_{class}, subject prediction result ŷₜₕₑₘₑ and first content label prediction result ŷ_{content-1} obtained.

The feature map is further input to a feature enhancement module 604. The feature enhancement module 604 can obtain importance degree of each feature channel based on the feature map; enhance features which have high importance degree in the feature map according to importance degree of each feature channel; and output a feature map which has been processed by feature enhancement.

The feature map, which has been processed by feature enhancement, is input to a spatial regularization net 606. It is processed by an attention network, a confidence degree network and a regularization network in a spatial regularization net, to obtain second content label prediction result ŷ_{content-2} of the image.

The weighted average ŷ_{content} of the first content label prediction result ŷ_{content-1} and the second content label prediction result ŷ_{content-2} is obtained by a weighting module 608. The label generation module 610 can generate label prediction result vector y₁=(ŷ_{class},ŷₜₕₑₘₑ,ŷ_{content}) from class label prediction result ŷ_{class}, subject label prediction result ŷₜₕₑₘₑ, and weighted content label prediction result ŷ_{content}.

In a label determination module 612, class label of the image is determined by carrying out calculation of softmax function on class label prediction result; and subject labels and content labels of the image are determined by carrying out calculation of sigmoid function on subject label prediction result and content label prediction result.

In some embodiments, as shown in FIG. 6, before being input to the label determination module 612, label prediction result vector y₁=(ŷ_{class},ŷₜₕₑₘₑ,ŷ_{content}) is input to K-dimensional full-connection module 614. The K-dimensional full-connection module 614 can output label prediction result vector y₂=(ŷ_{class}′,ŷₜₕₑₘₑ′,ŷ_{content}′), which has been processed by sematic correlation enhancement. Here K is the number of class label, subject labels and content labels ŷ_{class}′ is class label prediction result which has been processed by sematic correlation enhancement. ŷₜₕₑₘₑ′ is subject label prediction result which has been processed by sematic correlation enhancement. ŷ_{content}′ is content label prediction result which has been processed by sematic correlation enhancement. Label prediction result vector y₂=(ŷ_{class}′,ŷₜₕₑₘₑ′,ŷ_{content}′) which has been processed by sematic correlation enhancement, is output by the K-dimensional full-connection module 614, and is input to the label determination module 612 to generate a label set.

In some embodiments, a threshold value setting module 616 is configured to set a confidence threshold value for each label, and the label determination module 612 is configured to screen confidence degree of each label in subject label prediction result and content label prediction result, based on confidence degree threshold value set by the threshold value setting module 616, so that subject and content labels of the image are determined. Then a label set is generated, and the label set comprises class label, one or more of the subject labels and content labels.

According to an embodiment, existing label classification schemes are improved through combination with characteristic of image labels. Through introducing learning for enhancement of relation among different labels and threshold value of various labels, technical effect that one network can generate a single-label (class label) and multi-label (subject labels and content labels) of an image at the same time is achieved. Thus, label identification effect is improved, and calculation task of a model is reduced. Label data generated according to the scheme disclosed by the embodiments described herein can be applied in areas such as network image search, big data analysis, etc.

A “device” and “module” in various embodiments disclosed herein can be implemented by using hardware unit, software unit, or combination thereof. Examples of hardware units may comprise devices, components, processors, microprocessors, circuits, and circuit elements (for example, transistors, resistors, capacitors, inductors, etc.), integrated circuits, application specific integrated circuits (ASIC), programmable logic device (PLD)s, digital signal processors (DSP), field programmable gate arrays (FPGA), memory units, logic gates, registers, semiconductor devices, chips, microchips, chipsets, etc. Examples of software units may comprise software components, programs, applications, computer programs, application programs, system programs, machine programs, operating system software, middleware, firmware, software modules, routines, subprograms, functions, methods, processes, software interfaces, application program interfaces (API), instruction sets, computing codes, computer codes, code segments, computer code segments, words, values, symbols, or any combination thereof. The determination that whether hardware units and/or software units are used to implement an embodiment can be changed by any number of factors, such as desired calculation rate, power level, heat resistance, processing cycle budget, input data rate, output data rate, memory resources, data bus speed, and other design or performance constraints, as desired by a given implementation.

Some embodiments may comprise manufactured products. The manufactured products may comprise a storage medium to store logic. Examples of the storage media may comprise one or more types of tangible computer readable storage media which can store electronic data, comprising volatile memory or nonvolatile memory, removable or non-removable memory, erasable or non-erasable memory, writable or rewritable memory, etc. Examples of logic may comprise various software units, such as software components, programs, applications, computer programs, application programs, system programs, machine programs, operating system software, middleware, firmware, software modules, routines, subprograms, functions, methods, processes, software interfaces, application program interfaces (API), instruction sets, computing codes, computer codes, code segments, computer code segments, words, values, symbols, or any combination thereof. According to an embodiment, for example, the manufactured products may store executable computer program instructions. When they are executed by a computer, the computer is caused to perform methods and/or operations described by the embodiment. The executable computer program instructions may comprise any suitable type of codes, such as source codes, compiled codes, interpreted codes, executable codes, static codes, dynamic codes, etc. Executable computer program instructions may be implemented in a way of predefined computer language, mode or syntax, to instruct a computer to execute a certain function. The instructions may be implemented using any suitable high-level, low-level, object-oriented, visual, compiled and/or interpreted programming languages.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A computer-implemented method for identifying labels of an image comprising:
determining a first value of a single-label of the image and a first value of a multi-label of the image, based on a feature map of the image;
producing a weighted feature map from the feature map based on a characteristic of features of the feature map;
determining a second value of the multi-label of the image by performing spatial regularization on the weighted feature map;
determining a third value of the multi-label based on the first value of the multi-label and the second value of the multi-label.

2. The method of claim 1, wherein the characteristic is correlation of the features with the multi-label.

3. The method of claim 2, wherein the correlation is spatial correlation or sematic correlation.

4. The method of claim 1, wherein the third value of the multi-label is a weighted average of the first value of the multi-label and the second value of the multi-label.

5. The method of claim 1, further comprising determining a fourth value of the multi-label from the third value of the multi-label based on sematic correlation between the single-label and the multi-label.

6. The method of claim 5, further comprising applying a threshold to the fourth value of the multi-label.

7. The method of claim 1, further comprising determining a second value of the single-label from the first value of the single-label based on sematic correlation between the single-label and the multi-label.

8. The method of claim 1, further comprising extracting the feature map from the image.

9. The method of claim 1, wherein the multi-label is a subject label or a content label.

10. The method of claim 1, wherein the single-label is a class label.

11. The method of claim 1, wherein producing the weighted feature map comprises using a global pooling layer, a first convolution layer, a nonlinear activation function, a second convolution layer and a linear activation function.

12. The method of claim 1, wherein producing the weighted feature map comprises obtaining importance degree of each feature channel based on the feature map and enhancing those feature channels that have high importance degree.

13. The method of claim 1, further comprising extracting high-level semantic features of the image from the feature map.

14. The method of claim 1, further comprising applying a threshold to the first value of the single-label.

15. A computer program product comprising a non-transitory computer readable medium having instructions recorded thereon, the instructions when executed by a computer implementing the method of claim 1.

16. A computer system comprising:
a first microprocessor configured to determine a first value of a single-label of an image and a first value of a multi-label of the image, based on a feature map of the image;
a second microprocessor configured to produce a weighted feature map from the feature map based on a characteristic of features of the feature map;
a third microprocessor configured to determine a second value of the multi-label of the image by performing spatial regularization on the weighted feature map;
a fourth microprocessor configured to determine a third value of the multi-label based on the first value of the multi-label and the second value of the multi-label.

17. The computer system of claim 16, wherein the characteristic is correlation of the features with the multi-label.

18. (canceled)

19. (canceled)

20. The computer system of claim 16, further comprising a fifth microprocessor configured to determine a fourth value of the multi-label from the third value of the multi-label based on sematic correlation between the single-label and the multi-label.

21. (canceled)

22. The computer system of claim 16, further comprising a sixth microprocessor configured to determine a second value of the single-label from the first value of the single-label based on sematic correlation between the single-label and the multi-label.

23. The computer system of claim 16, further comprising a seventh microprocessor configured to extract the feature map from the image.
